(19) United States
(12) Patent Application Publication
(10) Pub. No.: US 2023/0082768 A1
(43) Pub. Date: Mar. 16, 2023

(54) CERTIFICATION APPARATUS FOR VOTING IN AN ELECTION

(71) Applicant: Amanda Geralyn Noe, Parker, TX (US)

(72) Inventor: Amanda Geralyn Noe, Parker, TX (US)

(21) Appl. No.: 17/722,980

(22) Filed: Apr. 18, 2022

Related U.S. Application Data
(60) Provisional application No. 63/244,124, filed on Sep. 14, 2021.

(51) Int. Cl. G07C 13/00; G06K 1/12

(52) U.S. Cl. CPC G07C 13/00; G06K 1/121; G06Q 2230/00

(57) ABSTRACT

An apparatus and method to certify a ballot for later verification or audit. The apparatus can receive the ballot and print, at a suitable area on the ballot, a certification code to certify the ballot. The certificate can include a serial number of the apparatus, name of the election, time and date of voting, a sequence number of the ballot, notary name, notary ID, Notary password, Election worker name, Election worker ID, Election worker password, GPS coordinates of the location of the apparatus, GPS date, GPS time, GPS ground speed, GPS tracking angle, Location name, location address, location ID, an image from a weather satellite of the cloud formation captured on the day of voting.

### CROSS-REFERENCE TO RELATED APPLICATIONS

This application claims priority from the U.S. provisional pat. application Ser. No. 63/244,124, filed on Sep. 14, 2021, which is incorporated herein by reference in its entirety.

### FIELD OF INVENTION

The present invention relates to a certification apparatus, and more particularly, the present invention relates to an apparatus and method to certify casting a vote in an election.

### BACKGROUND

In the United States, electronic voting machines replaced the paper-based ballot systems in many counties, intending to improve upon the drawbacks associated with the ageold paper ballot systems. However, electronic voting machines have their drawbacks and limitations. Electronic voting machines can be vulnerable to cyber-attacks and can be subject to fraudulent manipulation. From time-to-time people raise new concerns about electronic voting systems which can hurt voters by weakening their trust in fair elections. Additionally, mail-in paper ballots have raised a new concern about the integrity of elections.

There have been reports of votes being cast by deceased people, people who moved out of the city, people who may not be registered to vote, ineligible voters, inaccurate voter rolls, and many other discrepancies. Multiple scanning of the paper ballots had also been reported in the past.

When such concerns or claims of fraud are raised, auditing may be performed to verify the validity of ballots. However, it can be difficult to tell the difference between a paper ballot that was cast legally and properly by a registered voter and a ballot that was cast illegally by any means just by analyzing the ballot itself. Forensic audits seek to examine the ballot paper composition, ink composition, printing alignment and quality, method used to fill circles associated with candidates, creases in the paper in the case of mail-in ballots, and many other physical properties of the ballots. But physical properties of the ballots do not enable a forensic auditor to know the date, time, and place that the voter cast their vote.

Thus, a need is appreciated for certifying the casting of votes while the ballots are in the possession of the voters. A need is appreciated for notarization of the ballots at the time of casting the vote to help ensure authenticity and later aid in the validation of the ballots during an audit.

The term “ballot” hereinafter connotes a sheet of paper or cardboard used to cast a vote in elections and upon which the choice of voter is marked.

The term “voter” hereinafter connotes a person voting in an election.

The term “vote” hereinafter connotes a formal indication of a choice made by the voter in an election.

The phrase “casting a vote” or “cast a vote” hereinafter connotes a process by which a voter votes in an election.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a certifying apparatus for ballots that can certify the casting of votes for later audit or verification.

It is another object of the present invention that the certifying apparatus can operate autonomously.

It is still another object of the present invention that the certificate on ballots does not obscure the scanning of votes, bar codes, original markings, or voter markings on the ballot.

It is yet another object of the present invention that the disclosed apparatus is difficult to be manipulated.

It is a further object of the present invention that the disclosed apparatus can bolster the trust of people in fair voting.

It is still a further object of the present invention that the anonymity and secrecy of the voters and the voting process can be preserved.

It is an additional object of the present invention that the chain of custody of the ballot is preserved.

In one aspect, disclosed is an apparatus and method to certify the date, time and place of casting a vote. The disclosed apparatus can receive the ballot and print, at an appropriate area on the ballot, a certificate to certify the casting of the vote.

In one case, the certificate can include a serial number of the apparatus, name of the election, time and date of voting, notary name, notary ID, Notary password, election official name, election worker ID, election worker password, GPS coordinates of the location of the apparatus, location name, location address, location ID, an image of the polling station as captured by a camera coupled to the apparatus, an image from a weather satellite of cloud formation captured on the day of voting.

In one aspect, principles of blockchain technology can be applied for storing the records of casting the votes including the certificates, wherein each record can be stored as a block in the blockchain. Only part of the above record, i.e., a subset of the record can be printed on the ballot and the hash value of the respective block can also be printed on the ballot.

In one aspect, the hash value, also referred to hereinafter as only “hash”, can be printed in a form of an indicium that can be scanned by a suitable device to read the hash.

In one aspect, a ballot can be verified by comparing the hash on the ballot with the hash of certificates stored in the blockchain.

In one aspect, the data in blockchain can be encrypted and the encryption keys can be generated.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a block diagram showing a system architecture, according to an exemplary embodiment of the present invention.

FIG. 2 is a block diagram illustrating a record of casting a vote, according to an exemplary embodiment of the present invention.

FIG. 3 is a flow chart showing the steps of a method to certify the casting of a vote, according to an exemplary embodiment of the present invention.

FIG. 4 shows a satellite image of clouds, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an”, and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

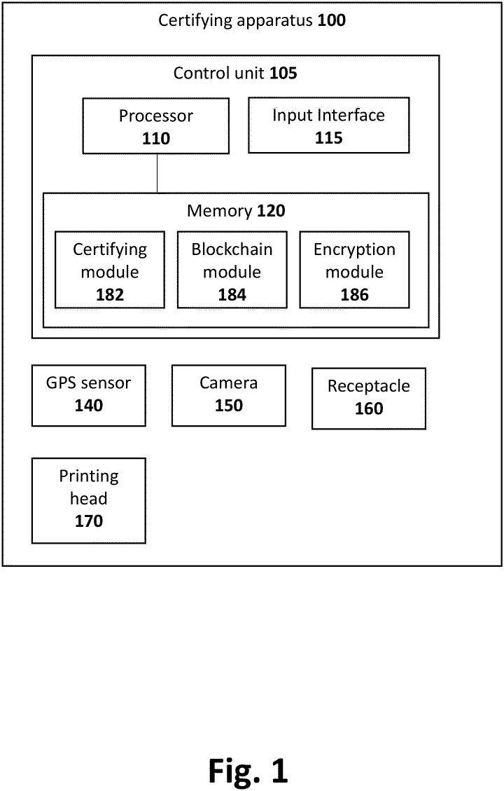

Disclosed are an apparatus and method to certify casting a vote in an election. The disclosed method can help verify at least the date and time of voting, and the location wherein the ballot is certified so that the ballot can be later verified, or an audit can be performed. Referring to FIG. 1, which shows an exemplary embodiment of an architecture of disclosed certifying apparatus 100. The certifying apparatus 100 can include a control unit 105, the control unit can include a processor 110 and a memory 120 operably coupled to each other. The control unit 105 can also include an input interface 115 for communicating with a person and receiving input from the person, such as the detail of elections being conducted as well as an image of the cloud formation captured by a weather satellite. While FIG. 1 shows a single input interface, a person reading this disclosure will appreciate that the input interface can include diverse input and output ports.

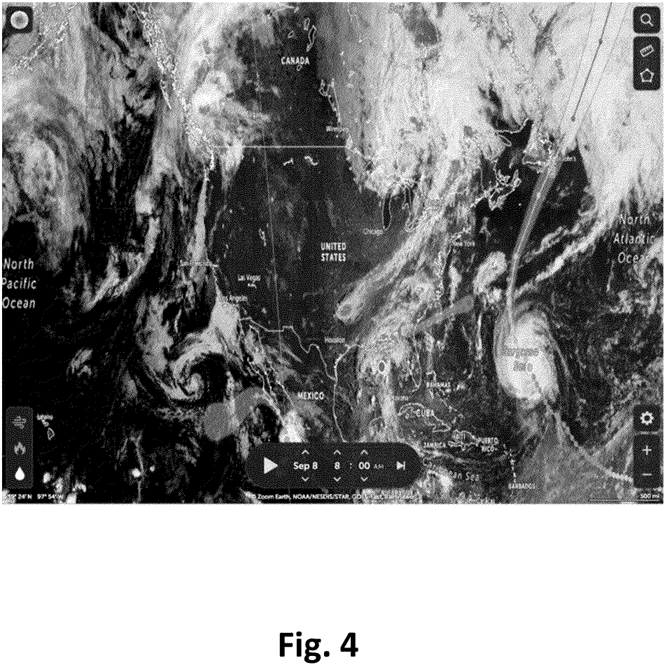

For example, a USB port, serial port, and the like are known to a skilled person for use in computers. The satellite image of clouds/weather can be uploaded through one of the input ports. For example, the image can be provided on a USB stick or a memory card, and the same can be connected to the apparatus by a notary. FIG. 4 shows such a satellite image of clouds. Alternatively, the control unit of the apparatus can connect to a server storing the satellite image through a network. The control unit can automatically retrieve the satellite image from the server through a preconfigured server address. However, such network access is optional and may not be a choice due to security reasons.

The disclosed memory can include a certifying module 182, a blockchain module 184, and an encryption module 186. The certifying module 182 upon execution by the processor can generate a record certifying the casting of a vote. The blockchain module 184 upon execution by the processor can provide for storing the records as blocks in a blockchain. The encryption module 186 upon execution by the processor can provide for encryption of the records. The image of cloud formation can be captured on the day of the voting by a weather satellite. The captured image can be embedded with metadata, the metadata can include information such as the date and time at which the image was captured and the geographical coordinates of the geographical area in which the image was captured. The metadata can allow tracking of the image source for verification. The inclusion of satellite images in the record can provide evidence against frauds such as post-dating of the votes, and the like.

The certifying apparatus 100 can further include a GPS sensor 140 to capture the current location coordinates of the certifying apparatus 100. A camera 150 can also be provided to capture an image of the surroundings of the certifying apparatus 100 within a view field of the camera 150. In one case, the camera can capture images in near real-time within the polling location. During mail-in ballot applications, the camera can take a picture of whatever surrounding environment is within the field of view of the camera. In certain embodiments, a predefined avatar or indicium can be placed within the field of view of the camera, such that the avatar or image is also captured by the camera with the surroundings. Such as avatar or indicium may be declared, known, or distributed on the day of the election and not known to anyone before the day of the election. Thus, such an image can become a piece of evidence during the audit.

A receptacle 160 may also be included, however optional, that can receive a ballot for processing and through which a stamped ballot can be output. A receptacle can include a slot similar to a voting machine. A GPS sensor typically finds more than just the location information, such as the time. All or part of such information from a GPS sensor can be captured in the record.

A printing head 170 can print/stamp a certificate on the ballot. While FIG. 1, shows the printing head as a part of the apparatus, however, a skilled person will appreciate that a separate printer can be connected to the disclosed apparatus through one or more input and output ports. The printer can be any commercially available printer, such as a laser printer, inkjet printer, thermal printer, and the like. Any type of printer or technology of printing on paper known to a skilled person can be used without departing from the scope of the present invention. The apparatus can include a housing that encases the different components of the disclosed apparatus including the printing head, GPS sensor, camera, receptacle, and control unit.

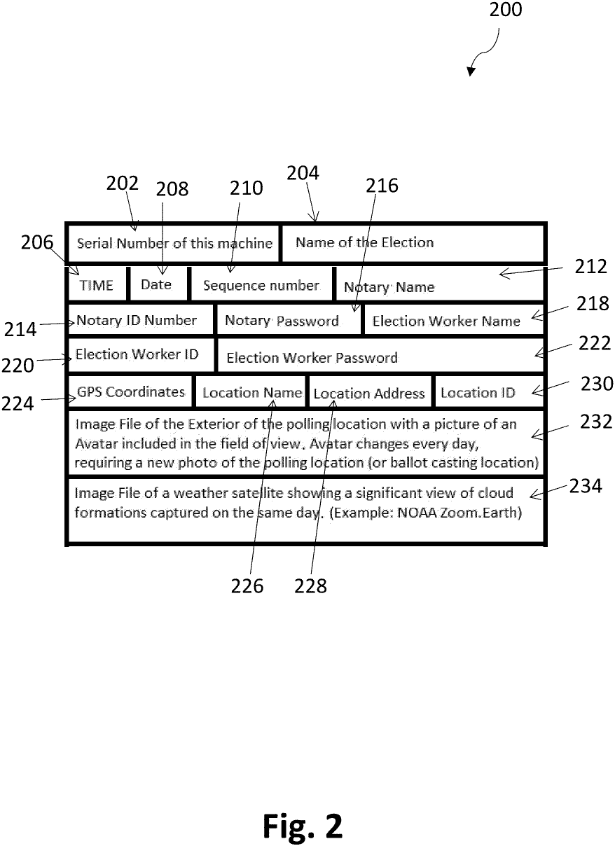

Referring to FIG. 2 which shows an exemplary embodiment of a record 200 to certify the casting of a vote for later validation and authentication, such as during an audit. The record can at least validate the date, time, and place where the respective ballot was certified. The disclosed apparatus can be configured for a voting session by authorized persons who can enter a few details of the election. Such authorized persons can be different from election officials. FIG. 2 shows the record having the serial number of the apparatus which can be read by the control unit from the apparatus i.e., the serial number of the apparatus. The record can optionally include the serial number of the other voting machines being used in an election session as well. The control unit of the apparatus can also receive details including the notary name and ID i.e., the name and ID of persons authorized to handle and operate the disclosed apparatus, such persons are herein referred to as “notary”. Additional information that can be received by the control unit can include the name of the election official and their IDs. The location at which voting is being conducted can also be fed by the notary person and includes the name and address of the location. The control unit can also receive an image of cloud formation captured on the same day by a weather satellite with enough detail and range to document a uniquely identifiable cloud pattern that is specific to the day and time of capture. The metadata of the image can include information, such as the source of the image, date, and time at which the image was taken. The control unit can also receive GPS data and location coordinates of the apparatus from the embedded GPS sensor. The disclosed apparatus may also include suitable sensors such as an accelerometer that can detect the movement of the apparatus. Additionally, the GPS sensors can continue to detect the current location coordinates of the apparatus while not in use for tracking purposes. The apparatus can incorporate the current location coordinates and should there be any movement of the apparatus in between the voting process, the location coordinates can be updated and the updated coordinates can be incorporated in subsequently generated records. While generating a record, the control unit can also capture an image of the surroundings of the apparatus by a camera coupled to the apparatus. This may however be optional. The record may also incorporate the image of cloud formations. A subset of record, i.e., a few selective information from the record can be printed on a ballot in an appropriate area that does not interfere with other information present or to be present on the ballot. The hash of the respective record can also be printed on the ballot. The bar codes, filled circles, alignment markings, and other official markings or text indicating the vote on the ballot are scanned by the voting machine and may not be obscured by the printing of the said information. The information can be printed as text, graphical representation, or a combination of both. The graphical representation can be in a form of QR codes and the like. For example, the hash value of the record in the blockchain can be printed as a graphical representation. The graphical representation can be scanned to read the data coded in the graphical representation. In certain embodiments, the printer can also have a paper tape receipt to provide another source of a paper trail for the audit. The QR codes with additional information can also be printed on the receipt. Moreover, the records, or hash value, or QR codes can also be saved locally, such as on a hard drive or USB stick. For example, the hash values can be stored in a form of a ledger on local storage.

In FIG. 2, block 202 includes a Unique Serial Number of The Notary Machine, block 204 includes a Text field entered by the Notary, such as Nov. 5, 2024 election, block 206 includes a Time based on the real-time clock within the notary machine, block 208 includes a Date Text field showing the date (battery backup), block 210 includes a Count of the number of ballots stamped, block 212 includes a Name of the Notary, block 214 includes a Driver Licenses of notary and witness, block 216 includes a notary password, block 218 includes an Election worker or Witness Name, block 220 includes a Driver Licenses of notary and witness, block 222 includes a password, block 224 includes a GPS coordinates based on built-in GPS receiver, block 226, 228 includes, and 230 includes Polling Location Information, block 232 includes a Photo image of Polling Location or other Building, block 234 includes a File capturing a weather satellite image captured on the same day.

It may be preferable to not print the entire record on a ballot, but the subset of records can be printed on the ballot and the record can be stored as a block in a blockchain. Each record can form a block and a hash value of the block can be printed on the ballot with other minimal information, such as the name and date, and place of election can be printed. It is understood that any other information may be printed with the hash value without departing from the scope of the present invention. Also, the principles of blockchain are known in the art, wherein the hash values of each block are based on the hash value of the previous block and the data record of the current block. The data in blockchain can also be encrypted and subsequently decrypted using standard encryption methods.

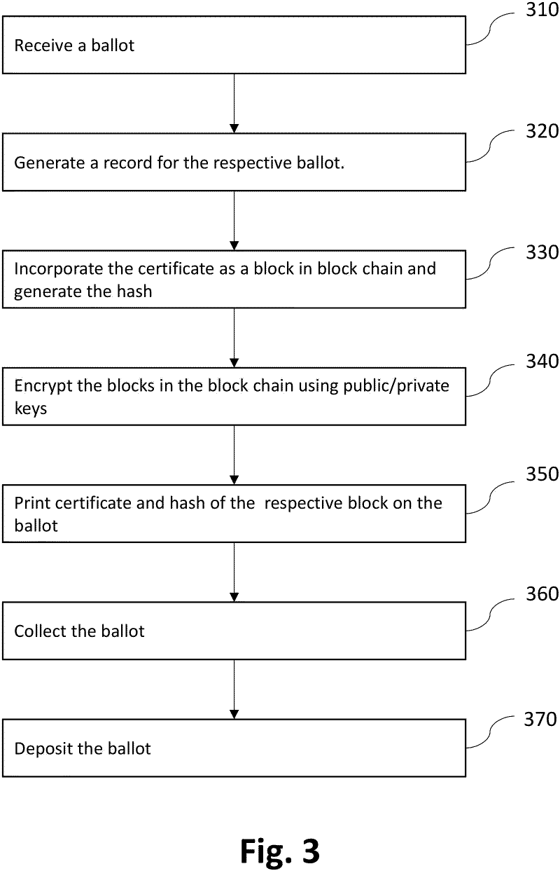

Referring to FIG. 3 which is a flowchart showing the steps of a method to certify casting a vote in an election session. The voter can receive a fresh ballot either at the polling location or via the mail or by any other authorized method, at step 310. The voter can indicate his vote on the ballot. The vote of the user can be indicated on the ballot in the form of alphanumeric characters, bar codes, filled circles, or any other method in accordance with local election procedures. The voter can then take their ballot and insert the ballot into the disclosed apparatus which can be observed and monitored by a notary in such a way as to maintain ballot secrecy. The disclosed apparatus can generate a record for the respective ballot, at step 320. The disclosed apparatus can include a clock for the current date and time to find the current date and time. Additionally, the apparatus can include a counter that can generate a sequence number. For each new ballot, the counter can be increased by one. The record can be incorporated into the blockchain, and a hash value can be generated at step 330. The blockchain can be encrypted, at step 340. A subset of the record including selective information and the hash value of the block can be printed on the ballot in the form of text, graphical representation, or a combination of both, at step 350. The voter can collect or remove the ballot from the apparatus, at step 360. The voter can deposit the ballot into another voting machine that scans or tallies the vote, into the mail in the case of mail-in ballots, or into a bin for collecting the ballots, at step 370. Regardless of the precise voting procedure for a given election or precinct, the pertinent requirement is for the voter, while in the passion of their marked ballot, to acquire a certificate printed on the ballot using the disclosed apparatus while being witnessed by the notary.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An apparatus for certifying a ballot in a voting process, the apparatus comprises:
a housing;
a GPS sensor configured to determine location coordinates of the apparatus, the GPS sensor encased in the housing; and
a control unit, wherein the control unit is configured to:
generate a record configured to certify casting of a vote,
store the record as a block in a blockchain, and
print at least a hash value of the block on the respective ballot, wherein the hash value is printed as a text or in a form of a graphical representation.

2. The apparatus according to claim 1, wherein the apparatus further comprises a clock and a counter, wherein the record comprises a current date and time derived from the clock, the record further comprises a sequence number generated by the counter, wherein the counter is configured to increase in value by a unit value upon each record generation, wherein the record further comprises a serial number of the apparatus.

3. The apparatus according to claim 2, wherein the apparatus further comprises an input interface, wherein the input interface is configured to receive a first image of cloud formation captured by a satellite of a pre-determined geographical area, wherein the record further comprises the first image.

4. The apparatus according to claim 3, wherein the control unit is further configured to encrypt the block.

5. The apparatus according to claim 3, wherein the apparatus further comprises a camera operably coupled to the control unit, wherein the camera is configured to capture a surrounding of the apparatus within a field of view of the camera, wherein the control unit is further configured to receive a second image from the camera, wherein the second image is incorporated in the record.

6. The apparatus according to claim 5, wherein the apparatus further comprises a printer configured to print the at least the hash value of the block on the respective ballot.

7. The apparatus according to claim 6, wherein the control unit is further configured to print the graphical representation on a paper receipt, wherein the graphical representation is a QR code.

8. The apparatus according to claim 1, wherein the control unit is further configured to store the record or the hash value of the block on a local storage, wherein the hash value of the block is stored as a QR code.

9. The apparatus according to claim 6, wherein the graphical representation is a bar code or a QR code.

10. A method for certifying a ballot in a voting process, method comprising the steps of:
providing an apparatus comprising:
a housing,
a GPS sensor configured to determine location coordinates of the apparatus, the GPS sensor encased in the housing, and
a control unit, wherein the control unit is configured to:
generate a record configured to certify casting of a vote,
store the record as a block in a blockchain, and
print at least a hash value of the block on the respective ballot,
wherein the hash value is printed as a text or in a form of a graphical representation.

11. The method according to claim 10, wherein the apparatus further comprises a clock and a counter, wherein the record comprises a current date and time derived from the clock, the record further comprises a sequence number generated by the counter, wherein the counter is configured to increase in value by a unit value upon each record generation, wherein the record further comprises a serial number of the apparatus.

12. The method according to claim 11, wherein the apparatus further comprises an input interface, wherein the input interface is configured to receive a first image of cloud formation captured by a satellite of a pre-determined geographical area, wherein the record further comprises the first image.

13. The method according to claim 12, wherein the control unit is further configured to encrypt the block.

14. The method according to claim 13, wherein the apparatus further comprises a camera operably coupled to the control unit, wherein the camera is configured to capture a surrounding of the apparatus within a field of view of the camera, wherein the control unit is further configured to receive a second image from the camera, wherein the second image is incorporated in the record.

15. The method according to claim 14, wherein the apparatus further comprises a printer configured to print the at least the hash value of the block on the respective ballot.

16. The method according to claim 15, wherein the control unit is further configured to print the graphical representation on a paper receipt, wherein the graphical representation is a QR code.

17. The method according to claim 10, wherein the control unit is further configured to store the record or the hash value of the block on a local storage, wherein the hash value of the block is stored as a QR code.

18. The method according to claim 15, wherein the graphical representation is a bar code or a QR code.
